(19) United States
(12) Patent Application Publication
(10) Pub. No.: US 2004/0107124 A1
(43) Pub. Date: Jun. 3, 2004

(54) Software Method for Regulatory Compliance

(75) Inventors: James Mark Sharpe, Mt Crested Butte, CO (US); Patricia Ann Moscarelli, Aurora, CO (US)

Correspondence Address: Jim Sharpe, 3 Copper Lane, Mt Crested Butte, CO, 81225-5310, US

(73) Assignees: James Mark Sharpe, Mt Crested Butte, CO (US); Patricia Ann Moscarelli, Aurora, CO (US)

(21) Appl. No.: 10/605,353

(22) Filed: Sep. 24, 2003

(51) Int. Cl. G06F 17/60

(52) U.S. Cl. 705/7

(57) ABSTRACT

Some acts of legislation impose various requirements on public and private entities. Generating awareness of these requirements and how they impact operations, as well as ongoing monitoring for compliance, is a complex problem. A solution to the challenge can be facilitated by a software system capable of simultaneously addressing multiple regulatory compliance requirements. The software method of this invention combines a unified ontology-based compliance model with reasoning elements to address compliance issues across multiple governance areas. The unified compliance model (UCM) allows a more effective identification and analysis of compliance issues that are common between separate regulatory acts as well as addressing interrelationships between multiple distinct regulations. By using a unified hierarchical ontology-based knowledge repository, the analysis software is able to operate on a consistent semantic representation of the information while facilitating the development and ongoing enhancement of the solution. Analysis and automated reasoning about the information in the knowledgebase can be implemented either as a capability of the built-in reasoners of the ontology system or via external analysis elements. The method of this invention can be applied to various issues common to regulatory compliance such as analysis of electronic, communications, network activity, or combinations of both. Additionally, financial analysis elements can utilize the unified compliance model to identify the costs associated with bringing an organization into compliance as well as provide planning support for optimizing a response in accordance with specified restraints.

### BACKGROUND OF INVENTION

Federal, State and Local Governments have issued legislation that imposes strict controls over how entities in the US conduct business in response to crimes such as fraudulent accounting, investment fraud, exposure of private information, cyber theft, and acts of terrorism. These new Acts of Governance affect both private and public enterprises, as well as enterprises not housed in the US but listed on the US stock exchange. Much of this legislation also influences the security and privacy policies of federal, state and local government. Legislation such as HIPPA, GLBA, and Sarbanes-Oxley, for example, effect how organizations deal with not only auditing and financial reporting but also exposure of their secure and private client information. Nearly every individual in the US today will be touched in some way by these new regulations.

Although the intent of these new Acts of Governance are focused on the common good, the regulations contained in any individual act, as well as those regulations common across legislation tend to conflict, and are sometimes in part redundant. The cost associated with implementing these new regulations can be significant. To the unknowing business entity the redundancy and conflicts, if not clearly identified, can have serious financial consequence as well as inadvertently negate the intent of the bill. Every opportunity must be taken to minimize the economic impact to the enterprise. An effective method of minimizing cost is to approach the issue of compliance in totality rather than bill by bill, or regulation by regulation.

By combining intelligent reasoning technologies, analysis capabilities, and a unified compliance model, that the method described by this invention can assist them in optimizing the business change associated with compliance. The Unified Compliance Model (UCM) enables the enterprise to consistently address compliance issues across multiple governance areas; model their business against a compliant business model; identify gaps; and provide a true understanding of the potential economic impact associated with implementation. Not only does this approach ensure the business can effectively deal with the economic impact of compliance but it actually facilitates the initial intent of the bill, to protect the common good, by identifying potential legislative conflicts that could force, quite unintentionally, the enterprise out of compliance.

A unified view on compliance often enables the enterprise to optimize and perform even better than before, as it forces the business to look at all policies, procedures and systems. Review and revamp of legacy systems rarely occurs, so inefficiencies are often overlooked, or bypassed for issues that are more current. A unified view of compliance actually tends to the drive the business to correct other inefficiencies while making compliance specific process changes.

Another capability surfaced by the Unified Compliance Model is an ability to monitor the system, providing near real-time feedback and alerts to management. This feedback enables management to respond more rapidly to potential issues, which minimizes cost to remediate. In traditional systems, most anomalies do not surface until they are compounded in another situation. Monitoring, in conjunction with sophisticated reasoning and analytic techniques, enable an event to be evaluated in its least complicated form thus reducing the cost of remediation. Another benefit of monitoring is management”s ability to fine-tune the business process based on metrics provided by the system.

Others have looked at solving the problem of cross governance compliance. Most have sliced off and attacked one particular piece of governance, such as Sarbanes-Oxley, or one particular compliance function, such as financial reporting. This approach, although helpful, can actually force the enterprise to incur more cost. Since they are unable to model the compliant business in totality, they have viewed the area as too complex, and opted to ignore cross-bill dependencies and redundancies. Yet others approaching compliance are treating the initiatives as purely consulting and manually constructing less-than effective plans for remediation. This approach does not add the additional value of long-term business improvement. One has to ask at this point, what happens when another new piece of legislation is released? Do I call the consultants back? The flexible unified modeling approach to compliance enables the enterprise to model bills in process and plan for upcoming change. Where traditional computing methods force the provider to enhance the software, a flexible model-based approached to compliance requires that you only update the model. Consultants focus on what they can charge for the engagement or product vs. what it actually costs the business to become compliant. By using a software method, which combines a unified compliance model in conjunction with sophisticated reasoning techniques and analytics a complete understanding of business cost, impact and scheduling, can be achieved across all areas of governance and compliance can be achieved and maintained.

Existing software techniques are adequate for many problems. However, as the complexity, and or, uncertainty of the input increases, traditional computational methods become increasingly inadequate. For some of these problem spaces, various soft computing methods such as neural networks, fuzzy logic, Bayesian processing, etc. have been quite successful. However, each of these technologies has various strengths and weaknesses and utilizes different models of uncertainty. Though existing techniques can sufficiently address small parts of an overall problem space, substantial value can be provided by a cohesive system that can effectively reason about the entire problem space while explicitly accounting for different forms of uncertainty. The complex problems involved in regulatory compliance analysis require a mix of traditional and soft computing technologies in a cohesive, multi-paradigm hybrid framework.

One of many guiding factors in determining what technology to apply is the nature of the information we have available on which to act. Sometimes we have data that contains a buried wealth of information, other times we have knowledge (rules). Additional issues arise because of the differences between the types and quality of information available to assess a given situation. Human sourced information is typically harder to characterize than other forms of information such as electronically collected network data. Each of these characteristics leads us towards a different solution based on the technology that is best suited to acting on a particular kind of information. Many complex real world problems cannot be effectively solved using a single approach in isolation, but require a combination of technologies and models.

One aspect of software based reasoning solutions is that they need to act more “intelligent”and be more tolerant of uncertainty than traditional software based systems. These characteristics are to some extent present in the way that humans approach the same kinds of problems. Although the purpose of this invention is not necessarily to mimic biological thought processes, there is sufficient common ground to make it a logical basis for the design of a software supported analysis system. From one standpoint, there are basically two ways that human analysts can approach a given situation. Both cases amount to dealing with the problem as more manageable parts, which are either more easily understood or deterministically addressed, as compared to approaching the entire problem at once. The design of the automated reasoning system for compliance must be able to support both forms of analysis.

Top-down—Prediction driven processing addresses questions of the type “Why is this?” In this case, the decomposition process identifies what information is necessary, or at least desirable, before a statistically valid inference can take place. The process repeats for each of the required pieces of information until either all mandatory information is obtained from atomic values or a roadblock is hit wherein one or more required pieces of information are unavailable and cannot be estimated by other means, in which case the deficiency is simply reported. If all the necessary information can be collected then it is applied according to the system model to produce the resulting “answer”.

Bottom-up—Data driven processing addresses questions of the type “What does this mean?” The bottom up process is essentially a sensemaking exercise where there initially exists some amount of basic information (observations) that need to be processed into progressively more relevant or understandable forms.

A process stack that describes how human analysts often approach problems can be described from the top down as Responses to Situations are recognized from Relationships identified from Inferred Entities detected from Observations. These five layers are equally relevant for either top-down or bottom-up forms of reasoning. Each successive layer is derived from information in the layer below it. The intent of the reasoning framework used by the method this invention is to provide optimal capabilities for producing and operating on information (knowledge) in each of the levels in the stack while effectively modeling and fusing uncertainty present in the information. Note that this process stack and the capabilities required to implement it are extremely generic. A framework capable of generalizing analysis capabilities across all the layers could be applied to a very broad range of problems. This invention specifically combines the reasoning framework approach with a unified compliance model to address problems related to regulatory compliance.

A specific algorithm or processing technology might be effective at addressing one small part of the overall stack, such as detecting an inferred entity from an observation, or classifying a group of inferred entities. It is the goal of the reasoning framework to incorporate those kinds of capabilities, along with others, into a solution capable of addressing the full stack. Many of the areas of interest relevant to regulatory compliance can be mapped to one or more locations in the stack.

One of several key aspects of the framework approach of the claimed invention is the use of a unified compliance model. This unified model is necessary to address in its entirety, the complex interrelationships between various different legislative acts, as well as, interactions between various business processes and costing models. Existing software systems related to supporting or analyzing regulatory compliance do not take this holistic approach. Typically they will have separate software representations for each legislative act or part of the business process and somehow tie them together using code or rules. In contrast, the approach taken in this invention uses the unified model as the basis that drives all the solutions capabilities. While model driven software architectures have been used in various capacities for a number of years, they have not been applied as a solution to the regulatory compliance problem space or used in conjunction with an intelligent reasoning framework.

The unified compliance model utilized by this invention could be represented using a wide variety of techniques. Although there are many traditional ways of modeling information such as databases or rule sets, none of these possesses the characteristics necessary for reasoning about the knowledge they contain. Ontologies, on the other hand, have a strong history of use for precisely the kind of modular hierarchical modeling required to represent a robust, unified compliance model. A primary advantage to using a hierarchy of ontologies to implement the unified compliance model is their ability to represent explicitly the semantic meaning of the knowledge they contain in a way that is suitable for use by software systems.

This invention combines the capabilities of hybrid, multi-paradigm reasoning framework with a unified ontology-based compliance model. The sophisticated analysis capabilities of the reasoning framework compliment the comprehensive information of the model to identify and address dependencies across and between different legislated requirements and/or business processes. Furthermore, because the model is the central element driving the overall solution, future refinements or additions to a solution based on the invention can be more easily accomplished with lower cost and greater reliability than is the case with non-model driven architectures.

### SUMMARY OF INVENTION

In summary, the combination of an advanced reasoning framework with a unified, ontology-based, compliance model is a unique approach to the problem. The UCM enables the enterprise to view compliance as a whole and choose the optimum path for execution. Most importantly, it enables the enterprise to pro-actively plan for new regulations as they are in process as well as monitor its current state of compliance and remediate effectively. Representing compliance information as a unified model creates a new, more stable, and in the end cost-effective means for enterprises to maintain compliance. The time lag associated with utilizing traditional computing methods to respond to the ever-changing business climate is not effective at allowing the enterprises to respond to the intent of the legislation.

### DETAILED DESCRIPTION

Many of the beneficial characteristics of this invention arise from the use of a unified model to represent compliance state and goals set forth by one or more pieces of legislation. This unified compliance model essentially creates a single semantic representation that can cross multiple compliance requirements as well as different business processes. For example, rather than creating separate systems and corresponding models for addressing issues related to the US Patriot Act and the Sarbanes Oxley Act, the method described by this invention would use a single model that encompasses both. Additionally, the contents of the model also contains knowledge relating to current and future states of one or more organizations type and level of compliance. Furthermore, the model may also contain information relating to the costs, time and resources associated with addressing each aspect of the compliance requirements.

The unified compliance model allows various forms of analytical reasoning to effectively identify and analyze relationships across and between diverse compliance issues. This concept is superior to the traditional approaches whereby separate systems are used to address each compliance area and the interrelationships are either left unaddressed, or dealt with in an ad hoc fashion by using external rules or other forms of software code to identify and operate on the relationships. Using the unified compliance model, the relationships and interdependencies are inherently present in the model as opposed to being added after the fact by external rules and/or code.

The unified compliance model can be at least partially created through the use of a text analysis system operating on the text of the legislation and producing elements in the knowledgebase. Additionally the model can be updated to account for new or modified legislation by the use of the same types of automatic text analysis. In either of these cases, the load on human analysts is reduced by having at least some of the elements of the unified compliance model produced or updated by automatic means.

The usage of a unified compliance model in and of itself is a significant step in providing an effective solution. However, there are many ways that such information could be represented, persisted, and operated on. This invention specifically uses a hierarchical collection of ontologies to represent and analyze the information in the unified compliance model. The hierarchical structure of the ontologies in the knowledgebase supports a modularization of the contained concepts and allows more advanced or specific concepts to be built from common or more general ones. For example, one or more ontologies are used to represent general compliance concepts while other ontologies build on the general concepts and support concepts relevant to a specific piece of legislation or business process. This collective set of interrelated ontologies together represents a single semantic processing space. This is significant because it is inherently and simultaneously self consistent and complete. All the possible relationships have been defined as part of the model structure as opposed to being defined by external code or rules, which may not capture all the possible relationships or represent conflicting or circular relationships.

Although there are a number of ontology languages that could be suitable for implementing the unified compliance model, some of the more interesting ones support certain forms of “built-in”reasoning capabilities. For example, the OWL web ontology language inherently supports the concept of reasoners, some of which are mathematically decidable. In addition to the reasoners directly supported by the ontology language, external analysis components can also be utilized either instead of, or in conjunction with, the directly supported reasoners. Examples of external analysis capabilities might include belief networks, fuzzy logic systems, artificial neural networks, etc.; either alone or in combination. The method described by this invention may utilize either the analysis/reasoning capabilities, which are provided using an ontology language or external analysis components or a combination of both.

A common aspect of many forms of governance is the need to monitor and analyze electronic communications such as email or instant messaging for compliance. The capabilities set forth by this invention are especially well suited for addressing compliance requirements specified by one or more legislative acts. When used for this purpose the unified compliance model would serve as the primary knowledgebase. Reasoning modules would analyze the contents of the communications for compliance violations. Because the knowledgebase would contain a model that represents all the relevant regulatory requirements, a single analysis pass would be sufficient to detect any violations. Furthermore, the use of a unified model would allow the system to detect issues not specifically described by a single piece of legislations but rather were the result of a complex relationship across and/or between separate regulatory requirements.

Using the same capabilities useful for addressing governance for electronic communications, the combination of a unified compliance model with internal and external reasoning elements could be used to detect, classify and respond to complex network activity.

In order to address effectively many of the security requirements presented by current and future legislation, best efforts must be made to protect the networks utilized by a regulated organization. As the sophistication of the potential attacks increase, so must the capabilities to detect and respond to them. Simple firewalls and other common techniques are simply not capable of detecting many more subtle ways of compromising the security of a network. An advanced reasoning framework comprising a combination of soft analysis technologies such as neural networks, fuzzy logic, belief diagrams etc. could be applied in conjunction with the unified compliance model to perform various tasks within the overall process stack. The utilization of multiple reasoning technologies allows each to be used for the portion of the problem for which it is most suited. No compromises need to be made to force one or two technologies to solve the entire analysis problem. For example, a large collection of tightly focused neural networks, each trained to detect a specific pattern of network behavior could be used for low-level detection. The inferred entities produced from this detection layer would be persisted in the ontologies making up the unified compliance model. Subsequently, a mid level classification layer, possibly using a fuzzy logic system, could classify the collections of events. Once again, the results from this cluster analysis would be persisted in the unified model. A high-level belief network could be subsequently utilized to assign probabilities indicating possible threats, violations or levels of compliance. Finally, an influence diagram could be utilized to generate an optimal response to the recognized situation. Note that the choice of each specific reasoning technology as well as the topology of the overall reasoning system for a particular solution is flexible and will likely vary from solution to solution.

In addition to utilizing the combination of a unified model with reasoning capabilities to address the separate compliance problems involving electronic communications and network activity, the method identified by this invention has the capability to identify and respond to activities resulting from combinations of network activity and electronic communication. This capability is important because certain forms of violation may not be detected through the analysis of only one type of monitoring.

The value of the method described by this invention can be applied to more than just governance requirements. It also has the ability to model and analyze the costs, time and resources necessary to bring an organization into compliance. By associating information such as costs and resources with the various elements in the unified model, the reasoning elements can perform one or more forms of financial analysis and response optimization to produce knowledge relating to the costs, resources, time, etc required to bring the organization to a specified level of compliance while accounting for specified constraints.

What is claimed is:

1. A method for using a software system to address multiple regulatory compliance requirements comprising a unified, ontology-based model representing both the regulatory legislation and the state of the organizations required to comply, in combination with one or more reasoning elements that operate against the model.

2. A method of claim 1 wherein the reasoning capability is provided by the direct support of the ontology language.

3. A method of claim 1 wherein the reasoning capability is provided by elements external to the ontology knowledgebase

4. A method of claim 1 wherein the ontology model of the regulatory compliance legislation is automatically created by a text analysis system operating on the text of the legislation and producing elements in the knowledgebase.

5. A method of claim 1 wherein the ontology model of the regulatory compliance legislation is automatically updated by a text analysis system operating on the text of the legislation and producing elements in the knowledgebase.

6. A method of claim 1 wherein the unified model addressing the regulatory requirement is used to analyze electronic communications for compliance.

7. A method of claim 1 wherein the unified model addressing the regulatory requirement is used to analyze network activity for compliance.

8. A method of claim 1 wherein the unified model addressing the regulatory requirement is used to analyze relationships between electronic communication, and network activity for compliance.
